(19) United States
(12) Patent Application Publication
(10) Pub. No.: US 2005/0187857 A1
(43) Pub. Date: Aug. 25, 2005

(54) Money market exchange traded funds

(76) Inventor: Robert Stanley Tull JR., Levittown, PA (US)

Correspondence Address: HOWREY LLP, C/O IP DOCKETING DEPARTMENT, 2941 FAIRVIEW PARK DR, SUITE 200, FALLS CHURCH, VA, 22042-2924, US

(21) Appl. No.: 11/050,640

(22) Filed: Feb. 18, 2005

Related U.S. Application Data
(60) Provisional application No. 60/546,981, filed on Feb. 24, 2004.

(51) Int. Cl. G06F 17/60

(52) U.S. Cl. 705/37; 705/35

(57) ABSTRACT

The invention provides money market exchange traded funds (MMETFS) and methods to allow trading of money market funds on an exchange. The invention includes a new settlement method for the money market exchange traded funds that allows creation and redemption of MMETFs on the primary market as well as settlement on the secondary market on a shortened timescale relative to other exchange-traded securities.

### This application claims priority to U.S. Provisional Patent Application Ser. No. 60/546,981, filed Feb. 24, 2004.

### BACKGROUND

Money market securities are very short-term debt securities issued by governments, financial institutions, and corporations that mature in about a year or less. Examples include treasury bills (T-bills), certificates of deposit (CDs), and commercial paper (CP). Money market securities are very low risk financial instruments, and thus have a lower rate of return than less conservative investments.

Commercial paper money market securities are unsecured short-term loans to corporations that are typically traded in large denominations on a dealer market. This limited distribution scheme has the effect of preventing individual investors from investing in commercial paper. However, individual investors may pool their resources to invest in commercial paper and other short-term debt securities by investing in money market mutual funds (“money market funds”). Money market funds are mutual funds that typically maintain a $1 net asset value per share while earning interest for the shareholder.

Money market funds are regulated under the Investment Company Act of 1940 and Securities and Exchange Commission (SEC) regulations, specifically Rule 2a-7. Under Rule 2a-7, money market funds may invest in short term debt securities with maturities of 397 days or fewer. The dollar weighted average maturity of securities held in money market funds under Rule 2a-7 must be 90 days or fewer. Additionally, Rule 2a-7 places several requirements on the quality of the securities held in money market funds, making the investments very low risk. The short term nature and low risk of the debt securities in a Rule 2a-7 money market fund allow fund managers to maintain a constant net asset value per share of the fund, which is required to be $1.

Generally, longer-term securities provide greater returns, but also carry greater risk. If the average maturity of securities held in a money market fund is too long, then the fund risks a decrease in the value of its shares if interest rates rise (e.g., the share price may dip below $1). An increase in interest rates would devalue fund shares because higher yield instruments than those held by the fund would be available to investors.

Money market funds currently settle on a T+0 or T+1 schedule, meaning that they settle on the same day (T+0) an order is placed or they settle on the next day (T+1), depending on what time of day an order is placed. Orders placed before about 11 a.m. EST are usually executed on the same day, allowing the buyer to benefit from overnight interest returns. Orders placed after about 11 a.m. are usually executed on the next day (T+1), and the buyer thus misses out on overnight interest.

Money market funds are sold on the primary market, meaning that shares are purchased from and redeemed with the fund company itself, usually through a broker. Settlement is assisted by the National Securities Clearing Corporation (NSCC), which guarantees both side of the trade.

Shares of money market funds are usually purchased through brokers, which charge fees and expenses up to 1% on assets to cover investment management and distribution costs. Additionally, the fund may charge common mutual fund fees including custodial and administrative fees. These fees and expenses have the effect of reducing the yields of money market funds. This yield reduction becomes especially problematic when interest rates are very low, as they have been recently. Such low interest rates have caused money market fund yields to drop as low as 0.5%. Further reductions could extinguish yields or force money market funds to subsidize expenses. There is thus a clear demand for money market fund products with lower fees and expenses than currently available products.

Completely separate from money market funds are a class of securities known as exchange traded funds (ETFs). The American Stock Exchange (AMEX) introduced ETFs in 1993 as a class of funds that can be traded intra-day on public stock exchanges. ETFs have generally been based on some recognized index and thus have publicly known and published holdings.

Like ordinary mutual funds, ETFs provide investors with convenient diversification, but they also provide convenient trading platforms in secondary markets such as stock exchanges. For example, ETF index funds consist mostly of shares of the stocks in the same proportion as those used to calculate stock market indices, and have market values that vary with those indices. Well-known exchange traded funds include the SPDR Trust (SPY), which tracks the S&P 500 Index, the Nasdaq 100 Trust (QQQQ), which tracks the Nasdaq 100 Indexi and the Diamonds Trust (DIA), which tracks the Dow Jones Industrial Average.

ETFs, like other exchange-traded securities, usually settle on a T+3 schedule. Shares of a security may be purchased or sold by an investor on an exchange, for example, through a broker. Clearance of the trade may occur during the trading day or the same evening, after the exchange closes. The exchange interfaces with the National Securities Clearing Corporation (NSCC) of the Depository Trust and Clearing Corporation (DTCC), sending data to the Continuous Net Settlement (CNS) process of NSCC regarding the trade, including the counterparties, the number of shares and identity of the security, the price, and the settlement date. The DTCC compares the data provided by the exchange with data provided by the broker and determines whether there is a conflict. If there is a conflict between the broker's data regarding the trade and the exchange's data regarding the trade, then the DTCC sends the broker and exchange a notice of the conflict. Any conflicts are resolved on the next trading day (T+1), and whatever party made the error corrects the error in the party's records and resubmits the correct data to the DTCC.

The NSCC acts as the central counterparty to the transaction on the following trading day (T+2), and guarantees that the transaction will settle on the third trading day following the transaction (T+3). On T+2, the DTCC sends both parties to the transaction information about the net dollar position of each party. The parties must fund the net dollar position so that the transaction settles on T+3. The benefit of this settlement system is that it allows net settlement, that is, a particular market participant need only provide to the DTCC the net cash and securities owed for all trades on a particular trading day. So if on day T a market participant purchased 100 shares of a stock, but sold 50 shares of the same stock, then on day T+2, the market participant need only furnish 50 shares of the stock (and whatever cash is owed for all transactions) to the DTCC for clearance.

An example of securities traded in the aforementioned manner are the Lehman Brothers iShares, which are bond funds that hold bonds with relatively long maturities compared to bonds held by money market funds. The shortest term for bonds held by the iShares bond funds is about two years. The intraday indicative value (IIV) of iShares, that is the value of the underlying securities used by investors to determine a fair trading price, is based on the prices of the underlying bonds. The iShares settle on a T+3 schedule, and are traded on the American Stock Exchange, as well as other secondary markets. Shares of the iShares funds may have a higher yield than money market funds, but they also have significantly greater interest rate risks. As interest rates rise, the values of the iShares funds suffer price declines.

A different settlement system exists for securities traded on the repurchase agreement (“repo”) market that allows for much faster settlement and reduced transaction costs, but does not allow net settlement because settlement is on a per-transaction basis. The repo market is an over-the-counter market used for short-term investment and borrowing with a security (typically a bond) as collateral. Repos are short-term (typically just overnight) contracts for the sale and future repurchase of the security, where the sale price and repurchase price are the same, but the seller/repurchaser pays interest for use of the funds that paid for the security.

Parties to repo transactions may have accounts with a clearing bank. Two large clearing banks that operate within the New York Federal reserve system of the Federal Reserve are JP Morgan Chase and the Bank of New York. A buyer may then transfer cash to purchase the FED eligible debt securities into the buyer's clearing bank account, while the seller transfers the securities to be sold into the seller's clearing bank account. When the cash and securities are in place, the clearing bank executes an exchange. The exchange execution typically happens on the same day the trade was made (T+0).

Actively managed mutual funds, including money market funds, currently do not trade on secondary exchanges due to a variety of technical obstacles. Recently, however, the AMEX has proposed solutions allowing exchange trading of actively managed mutual funds. The AMEX's solutions are the subjects of several pending patent applications, namely, U.S. patent application Ser. Nos. 09/536,663; 09/536,258; 09/815,589; 10/174,505; 10/123,779; and 10/753,069.

Currently, there are no money market funds that trade on public exchanges. However, such a fund would likely enjoy broad popularity among investors who invest in money market funds because exchange trading would provide additional liquidity and transparency. There is thus a need in the financial industry for money market exchange traded funds (“MMETFs”).

### SUMMARY

It is thus an object of the present invention to provide MMETFs, money market funds that may be traded on secondary markets. A further object of the invention is to provide MMETFs with lower costs and higher yields to investors than current money market funds. A further object of the invention is to provide MMETFs with shorter settlement times than conventional exchange traded funds (ETFs).

The invention includes an exchange traded cash investment fund product comprising an investment fund with substantially all of its assets invested in short-term debt securities, wherein shares of the fund are purchased with an in-kind creation basket or cash on a first day using the FED and DTC direct withdrawal at custodian (DWAC) creation process on a DTC computer system. In some embodiments, settlement of the purchase of shares on the first day occurs on the first day. In some embodiments, settlement of the purchase of shares on the first day occurs through a tri-party bank, wherein the purchaser in an authorized participant who electronically transfers securities comprising the in-kind creation basket or cash in the authorized participant's tri-party bank account, the fund electronically transfers an equivalent value of fund shares in the funds' tri-party bank account, and the tri-party bank electronically transfers the fund shares to the authorized participant's tri-party bank account and the securities or cash into the funds' tri-party bank account. In some embodiments, shares of the fund are traded on an exchange using an exchange computer system with automated order executions. Some embodiments include a computer system comprising an index calculation engine that calculates an intra-day indicative value of the fund shares. In some embodiments, the computer system comprising an index calculation engine further comprises a means for publishing the calculated intra-day indicative value of the fund.

The invention further includes an exchange traded cash investment fund product comprising: an investment fund with substantially all of its assets invested in short-term debt securities, wherein shares of the fund are redeemed with an in-kind redemption basket or cash on a second day using the FED and DTC direct withdrawal at custodian redemption process on a DTC computer system. In some embodiments, settlement of the redemption of shares on the second day occurs on the second day. In some embodiments, settlement of the purchase of shares on the first day occurs through a tri-party bank, and wherein the purchaser in an authorized participant who electronically transfers securities comprising the in-kind creation basket or cash in the authorized participant's tri-party bank account, the fund electronically transfers an equivalent value of fund shares in the funds' tri-party bank account, and the tri-party bank electronically transfers the fund shares to the authorized participant's tri-party bank account and the securities or cash into the fund's tri-party bank account. In some embodiments shares of the fund are traded on an exchange using an exchange computer system with automated order executions. In some embodiments, the invention includes a computer system comprising an index calculation engine that calculates an intra-day indicative value of the fund shares. In some embodiments, the computer system comprising an index calculation engine further comprises a means for publishing the calculated intra-day indicative value of the fund shares to the consolidated tape system or any public or private data distribution network, including the Internet.

The invention further includes a method for creating shares of an actively managed or index based exchange traded cash investment fund product with substantially all of its assets invested in short-term debt securities, comprising the steps of: accepting an electronic transfer of an in-kind creation basket of securities and/or cash from an authorized participant for the purchase of shares of the fund into an account of the authorized participant, the account being in a computerized electronic database of accounts, accepting an electronic transfer of shares of the fund with an equivalent value to the in-kind creation basket of securities and/or cash into an account of the fund, the account being in the computerized electronic database of accounts, electronically transferring the in-kind creation basket of securities or cash from the account of the authorized participant into the account of the fund, and electronically transferring the shares of the fund from the account of the fund into the account of the authorized participant, wherein both of the accepting steps and both of the electronically transferring steps occur on the same day.

In some embodiments of this method, a tri-party bank computer system executes both of the accepting steps and both of the electronically transferring steps. In some embodiments, shares of the fund are traded on an exchange using an exchange computer system with automated order executions. In some embodiments, the method further comprises the steps of:. comparing data from the exchange regarding the trade of the shares of the fund with data from a broker regarding the trade of the shares of the fund, finding a difference between the data from the exchange and the data from the broker, and resolving the difference. Some embodiments further comprise the step of calculating an intra-day indicative value of the fund on an exchange computer system. Some embodiments further comprise the step of electronically sending the calculated intra-day indicative value of the fund to a consolidated tape system. Some embodiments further comprise the step of daily electronically transferring data comprising a portfolio composition file that contains a database of the quantity of each of the securities held by the fund. Some embodiments further comprise the steps of: electronically calculating a value of the fund using the portfolio composition file on a computer system maintained by an authorized participant, and comparing the value of the fund share calculated by the computer system maintained by the authorized participant using the portfolio composition file with the intra-day indicative value.

### DESCRIPTIONS OF THE DRAWINGS

FIG. 1 depicts the transaction flow in one embodiment of the money market exchange traded funds invention.

FIG. 2 depicts the overall data flow in one embodiment of the money market exchange traded funds invention.

FIG. 3 depicts the data flow in the exchange trade aspect of one embodiment of the money market exchange traded funds invention.

FIG. 4 depicts the data flow, calculations, and use of data from intra-day indicative value (IIV) calculations for one embodiment of the Rule 2a-7 non-compliant money market exchange traded funds invention.

FIG. 5 depicts the data flow in the tri-party bank aspect of one embodiment of the trading of the money market exchange traded funds invention.

### DETAILED DESCRIPTION

The invention includes money market exchange traded finds (MMETFs), which are short-term cash investment finds. Two embodiments of the invention are Rule 2a-7 compliant and Rule 2a-7 non-compliant MMETFs. The various embodiments of the MMETFs have similar investment objectives, namely to invest in relatively short-term securities in order to provide low-risk investments with a good return. The Rule 2a-7 compliant MMETFs comprise dollar-average securities with maturities ranging from 7 to 90 days, with no individual security having a maturity of greater than 397 days. Rule 2a-7 non-compliant MMETFs comprise dollar-average securities with maturities ranging from 7 to 180 days, or more, and each individual security may have a longer maturity. Another difference includes the target closing net asset value (NAV) of shares of the two types of fund. (Closing NAV is the price per share of a fund at market close.) MMETFs that are Rule 2a-7 compliant may have an expected closing NAV of $1 per share, while Rule 2a-7 non-compliant MMETFs may have a floating NAV that varies according to the closing NAV of the ETF fund assets.

The MMETFs of the invention may be actively managed funds, meaning that a fund manager decides on a daily basis which securities to buy for the fund and which to sell from the fund. The MMETFs may be traded on public exchanges using either an open outcry market or an electronic market, or any type of combination of the two.

In one embodiment, the bid and offer prices, i.e., the maximum price buyers will pay for shares of a fund and the minimum price sellers will accept for shares of the fund, may be calculated using a “portfolio creation file” (PCF). The PCF is an electronic database that contains the identities and quantities of each of the securities held by the fund. The PCF may be established daily by the fund manager, and published for use by investors to determine the intraday indicative value of a fund share. Alternatively, the PCF may be updated by the fund manager more frequently, for example, the PCF may be updated to reflect all changes (purchases and sales of securities) to the fund throughout the trading day.

Investors may favor MMETFs over traditional money market funds because MMETFs may be organized such that they have a reduced investor fee structure compared to traditional money market funds. It is anticipated that fees and expenses for MMETFs would be only 15-25 basis points or less (that is 15-25 hundredths of a percent, or 0.15-0.25%, of the price of a share). Thus, if the gross yield on shares of an MMETF is 1%, the net yield would be 1%-0.15%=0.85%. The fees and expenses for MMETFs cover investment management, custodial fees, fund administration, and the fund transfer agency. Custodial fees typically run about 3 basis points, and transfer agency fees are typically less than 1 basis point. Other fees, including investment management, would be about 10 basis points. (This calculation does not include per-trade broker commissions, but broker fees are fixed fees that do not generally depend on transaction size, and are thus insignificant for larger trades.) The fees and expenses for MMETFs would thus be much lower than those for traditional money market funds, which charge fees and expenses of 38 basis points or more.

In one embodiment, the invention includes a creation and redemption system for buying shares from and selling shares back to the fund company. In this embodiment, only limited types of transactions may be conducted with the fund company itself, in part to encourage trading on the secondary market. It is anticipated that, like other ETFs, MMETFs will issue shares only in large aggregations called “creation units” of many thousands of shares. Creation units may be purchased with “portfolio deposits” equal in value to the NAV of the MMETF shares in the creation units. The MMETF manager may publish daily a set of permissible securities (the “creation basket”) eligible for deposit to the fund in return for shares of the MMETF. Likewise, shares of MMETFs may only be redeemed with the fund company in creation unit aggregations. Redemption of MMETF shares may be for cash, or the fund manager may provide an investor redeeming a creation unit with a “redemption basket,” that is a set of securities with the same NAV as the creation unit. The compositions of redemption baskets may also be published by the MMETF manager daily.

Share creation and redemption may operate on a T+0 primary creation process, that is, settlement of creation and redemption transactions may be settled on a same-day basis. In one embodiment, authorized participants (APs) may elect to use any settlement schedule (T+0, T+1, T+2, or T+3 ) provided by the MMETF company for creation and redemption of MMETF shares. The creation/redemption process may use a combination of bank processing techniques, including settlement through the Federal Reserve banking system (FED) and the Depository Trust Company (DTC) Deposit and Withdrawal at Custodian (DWAC) creation/redemption process. The DTC is a central depository for investors, brokers, banks, custodians and APs, who deposit securities with the DTC for transfer to other DTC participants. The DTC, through its nominee Cede & Co., clears and settles security transactions and provides for automated transfer of deposited securities. This allows electronic security transfer, without the need to physically transfer the security certificates themselves, thus speeding up the settlement process and reducing the risks to participants. In some embodiments, the creation process may accommodate the transfer of securities into and out of the fund using a control process within a custodial bank, even when the FED and DTCC are closed, by using a custodial bank that conducts after-hours transactions.

In the DWAC creation process, an AP investor may deposit the value of one or more creation units of an MMETF with the DTC, FED, or a custodial bank either by depositing cash or a creation basket of securities (a so-called “in-kind” creation process). The MMETF's authorized participant likewise deposits the creation units with the DTC, which then executes the trade. Likewise, in the DWAC redemption process, an AP investor may deposit one or more creation units of MMETF shares with the DTC, or a custodial bank, and the MMETF's authorized participant may deposit a corresponding value of cash or a redemption basket of securities of equivalent value with the DTC or custodial bank, which then completes the redemption process to the AP. The costs of these electronically automated transactions are minimal.

The use of creation units for creation and redemption of MMETF shares will discourage most investors from conducting transactions with the MMETF company itself because most investors will not wish to deal with such large volumes of MMETF shares. Instead, transactions on the primary market will be conducted by large institutional investors and arbitragers, who can then trade excess shares of the MMETF on secondary markets such as public stock exchanges. Smaller investors can buy and sell smaller volumes of MMETF shares only on secondary markets such as stock exchanges, thus encouraging trading on secondary markets and providing liquidity.

In addition to T+0 settlement schedule for primary transactions with the MMETF company itself, other embodiments of the invention include a T+0 settlement schedule for MMETF transactions on secondary markets, such as public stock exchanges, as well. This unique T+0 settlement scheme for MMETFs is an entirely new concept for ETFs of any sort; indeed a T+0 settlement scheme is entirely novel for any type of security traded on secondary exchanges. The standard settlement scheme for ETFs and all other securities traded on secondary exchanges is the trade date plus three business day settlement cycle (T+3). Thus, in one embodiment, the invention includes a novel method for reducing the settlement times for trades of all types of securities on secondary exchanges. It is anticipated, however, that the benefits of a reduced settlement time will primarily benefit the MMETFs of the present invention. Furthermore, while T+0 settlement is made possible in this embodiment, it is equally possible to introduce T+1 and T+2 settlement schedules (or any other settlement schedules) as well with a simple variation, namely, by agreement among the trading parties.

In some embodiments of the invention, Rule 2a-7 compliant MMETFs may close for immediate execution on the exchange on or before some predetermined time, for example, 1 p.m. After this time, all further orders may be treated as market on close (MOC). All balanced orders (i.e., matched buy orders and sell orders) may then be executed at close. All Rule 2a-7 compliant MMETF orders not balanced at market close may be executed on a “best efforts” basis. Specialists and APs may attempt to execute all MOC orders until the orders in-balance would compromise the $1 per share price of the Rule 2a-7 compliant MMETF.

The invention includes unique handling of transactions involving Rule 2a-7 compliant and Rule 2a-7 non-compliant MMETFs. Public exchanges such as the American Stock Exchange can easily support transactions involving shares of Rule 2a-7 compliant MMETFs, with automated executions and market order types. Transactions involving MMETFs that are not Rule 2a-7 compliant, however, have the additional complication that some indication of their value must be provided to market participants. To achieve this, secondary markets may use the PCF in order to calculate and publish the intra-day indicative value (IIV) of fund shares. For example, an IIV may be calculated every 5 seconds during exchange hours, and published every 15 seconds over a consolidated tape or private distribution channels. In addition to the IIV, exchanges may publish the latest yields of MMETFs over the consolidated tape as separate symbols. Frequent publication of an IIV for MMETFs will allow shares of Rule 2a-7 non-compliant funds to trade with narrow bid/ask spreads.

The real time distribution of an IIV for Rule 2a-7 non-compliant MMETFs will permit investors to immediately compare the various competitive short-term cash products to the MMETFs. The transparent nature of Rule 2a-7 compliant MMETFs can serve as a solution to the problems of market timing and disclosure that currently plague money market fund providers. Investors typically have a greater degree of confidence in exchange listed products, and the regulatory supervision that accompanies exchange listing should provide MMETF products that investors will feel safe investing in.

Shares of Rule 2a-7 non-compliant MMETFs may accrue interest daily, net of expenses, and the net may be reflected in the NAV and distributed periodically (e.g., quarterly) to investors. Net interest earned on Rule 2a-7 compliant MMETFs may be accrued daily and distributed periodically (e.g., monthly) to investors. MMETF investment advisors and sub-advisors may manage maturities, redemptions, and creations in order to minimize capital gains generated by coupon payments and maturities. Unlike traditional money market funds and Rule 2a-7 compliant MMETFs, there need be no effort to protect the price per share of Rule 2a-7 non-compliant MMETFs.

Investors may benefit from MMETFs because of the short settlement times, similar to existing money market funds, but potentially days shorter than the existing settlement structure for ETFs and other exchange-traded securities. Furthermore, MMETFs will likely be simple to implement. The same-day creation and redemption process will allow current ETF service providers to enhance their service offerings with MMETFs and consequently enhance their ability to attract new ETF issuers. Furthermore, to improve the long-term success of MMETF products, United States based MMETFs may be cross-listed into foreign markets. For example, the AMEX has pioneered a global network for ETFs allowing cross-listing or registration of U.S.A. domiciled ETFs into Amsterdam and Singapore. Such networks provide opportunities to offer U.S. dollar investments into foreign markets with competitive yields into markets where interest rate returns, in real dollar terms, may not be available to many investors.

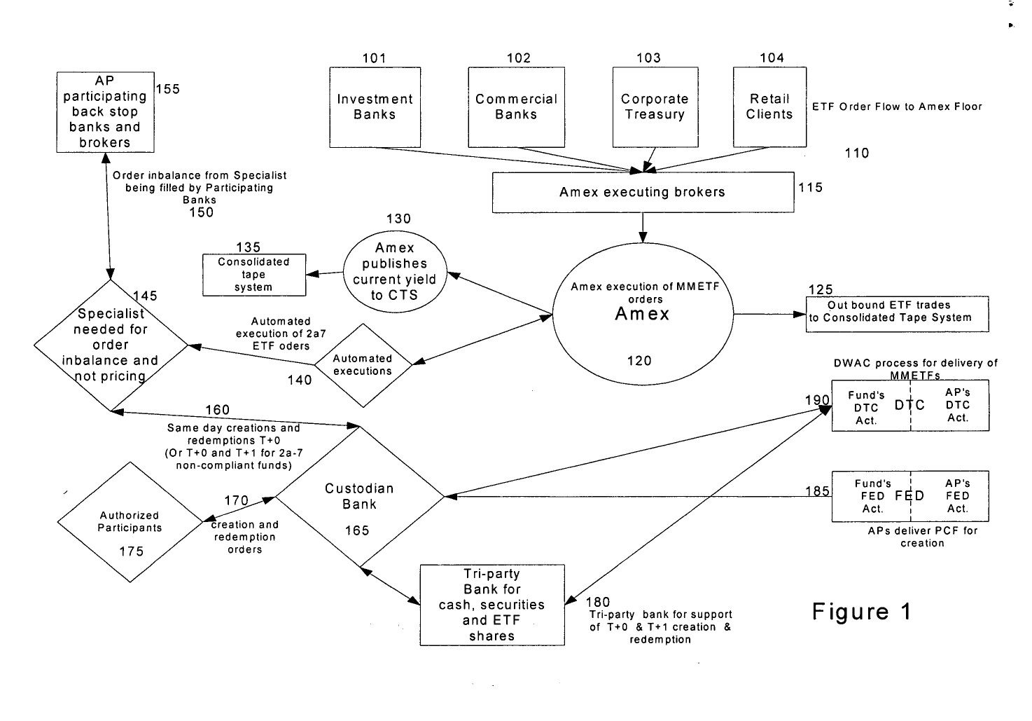

FIG. 1 depicts the transaction flow in one embodiment of the invention involving money market exchange traded funds. In the embodiment depicted in FIG. 1, MMETFs of the invention are traded on the secondary market of the American Stock Exchange (AMEX). In this embodiment, orders for shares of MMETFs are received 110 by AMEX executing brokers 115 from investors including investment banks 101, commercial banks 102, corporate treasuries 103, and retail clients 104. The orders are executed on the exchange 120, and each of the trades are sent to be recorded on a consolidated tape system (CTS) 125. The current yield of the MMETF is likewise published 130 to the CTS 135. The trades may be executed using automated trading systems 140, or known open outcry methods of secondary market exchanges. During times of balanced trading, when buy orders approximate sell orders, the normal automated or open outcry exchange system is sufficient.

However, during times when either buy orders or sell orders dominate, in order to balance buy orders with sell orders to ensure liquidity, specialists 145 may step in and provide the other half of a transaction. Specialists' orders at these times may be backed 150 by a select group of authorized participant banks and brokers 155. The authorized participants 175 may then conduct transactions with the MMETF company through a custodian bank 165, to either create or redeem orders 170 in order to provide shares when demand is high or redeem shares when demand is low.

An AP may transact with the custodian bank 165 either through the Federal Reserve FED 185, or through the DTC 190 and a tri-party bank 180. If the transaction is through the FED 185, the AP may deliver cash or a creation unit through the AP's FED or DTC account, while the MMETF company delivers an equivalent value of MMETF shares through its DTC account, to the custodian bank 165, which then matches the accounts and executes the trade. It is expected that such a transaction will require the normal T+3 settlement time.

In order to achieve T+0, T+1, or T+2 settlement times, settlement through a tri-party bank 180 is preferred. In this embodiment, an AP deposits cash or securities either in its DTC account or directly with a tri-party bank, while the MMETF company deposits an equivalent value of MMETF shares, in its DTC account. The tri-party bank then matches the accounts and executes the trade by moving the assets into the ETF fund and transferring the ETF fund shares to the AP's account at the DTC using the DWAC process, which is open until 6 p.m. within the DTC end-of-day (EOD) processing cycle.

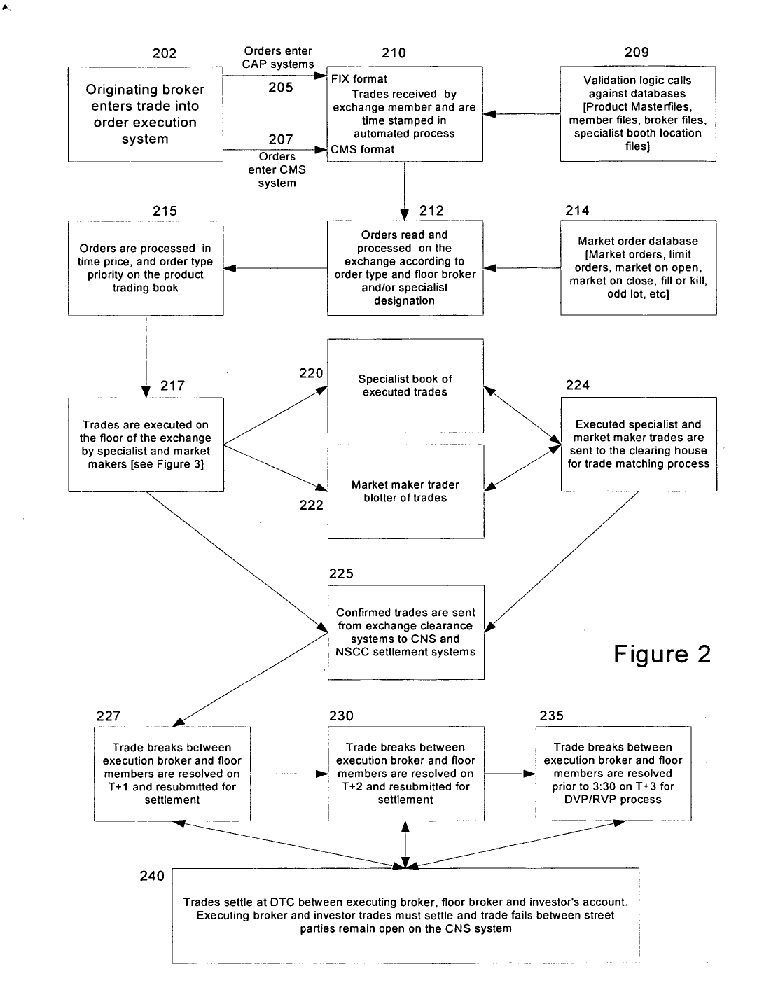

FIG. 2 provides an overview of the data flow among the various participants in an embodiment of the methods of the invention. An originating broker 202 receives an order from an investor, and enters a trade into the order execution system. The order may be entered 210 using Central Access Point (CAP) systems, which receive execution order data in the FIX protocol format 205, a fixed instruction format protocol developed by Salomon Brothers and known to those skilled in the art. Alternatively, the order may be entered 210 using the Central Message Switch (CMS) 207 of the independent tape system (ITS), an older instruction format for sending execution orders to U.S. stock exchanges, as known to those skilled in the art.

The order is then validated 209 by checking the order against databases including product master files, security files that hold a list of all exchange traded securities for members of the ITS, member files, which hold a list of the members of all US exchanges, broker files, which hold a list of all valid broker dealers registered in the US who can execute orders for investors, and specialist booth location files, which hold a list of the locations on the exchange floor where each specialist is located for each stock traded on the exchange. This validation system prevents the exchange floor from receiving erroneous orders entered into the CMS and CAP systems.

After an order has been validated, the order data is read and processed on the exchange 212 according to the order type and floor broker and/or specialist designation. The order is recorded in the market order database 214, and characterized in the database by order type as a market order, limit order, market on open, market on close, fill or kill, odd lot, etc. Only valid order types can be processed by exchanges, and valid order types vary from exchange to exchange, because not all exchanges can handle all order types. The order is then placed in the electronic trading book 215, and organized, for example, by time the order is placed, price, or type of order. Each exchange has rules covering what order types take precedent in their trade processing cycle.

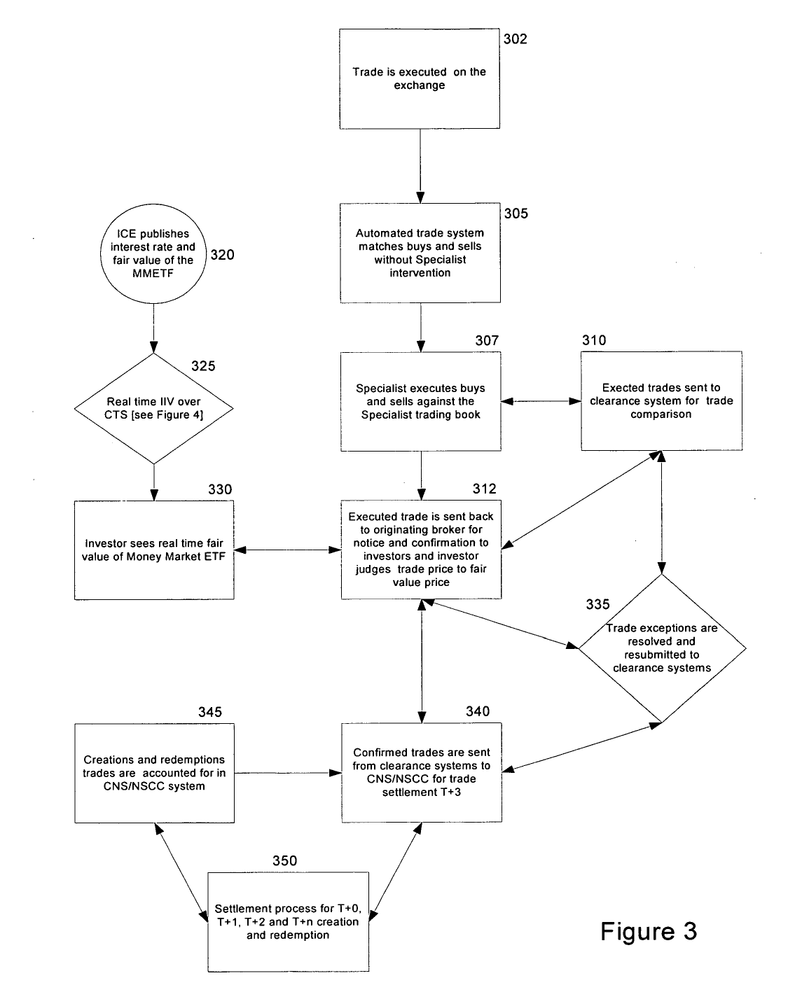

The order is then executed 217 on the floor of the exchange by specialists 220 and market makers 222. The execution process 217 is detailed in FIG. 3, described below. Data characterizing trades executed by the specialists 220 and market makers 222 are sent to the clearing house 224 for the trade matching process. Confirmed trades 225 are sent from the exchange clearance systems to the DTC's continuous net settlement (CNS) or NSCC settlement systems.

If there is any discrepancy between the broker's records regarding the trade and the exchange member who was the counterparty, the parties are notified of the discrepancy, the discrepancy is resolved, and the trade is resubmitted for settlement 227 on the next day (T+1). The trade then settles at the DTC 240 between the executing broker, the exchange member, and the investor's account. Executing broker and investor trades must settle, but trade fails between street parties (any professionals on the side of a trade that does not include a retail or institutional investor) remain open on the continuous net settlement (CNS) system. If exchange trade details do not match between all interested parties, the trade does not settle and is bounced back to the position brake room for resolution between the specialist's book, executing broker and/or market maker. Alternatively, discrepancies may be resolved on T+2 (230), T+3 (235), or any other prearranged settlement schedule.

FIG. 3 shows the details of data flow within an exchange trading system. Data characterizing a trade executed on the exchange 302 is provided to an automated trade system 305, which can match buy orders and sell orders without the need for specialist or market maker intervention. Alternatively or in addition to the automated trading system, specialists and market makers may execute buy and sell orders against the specialist or market maker trading books 307.

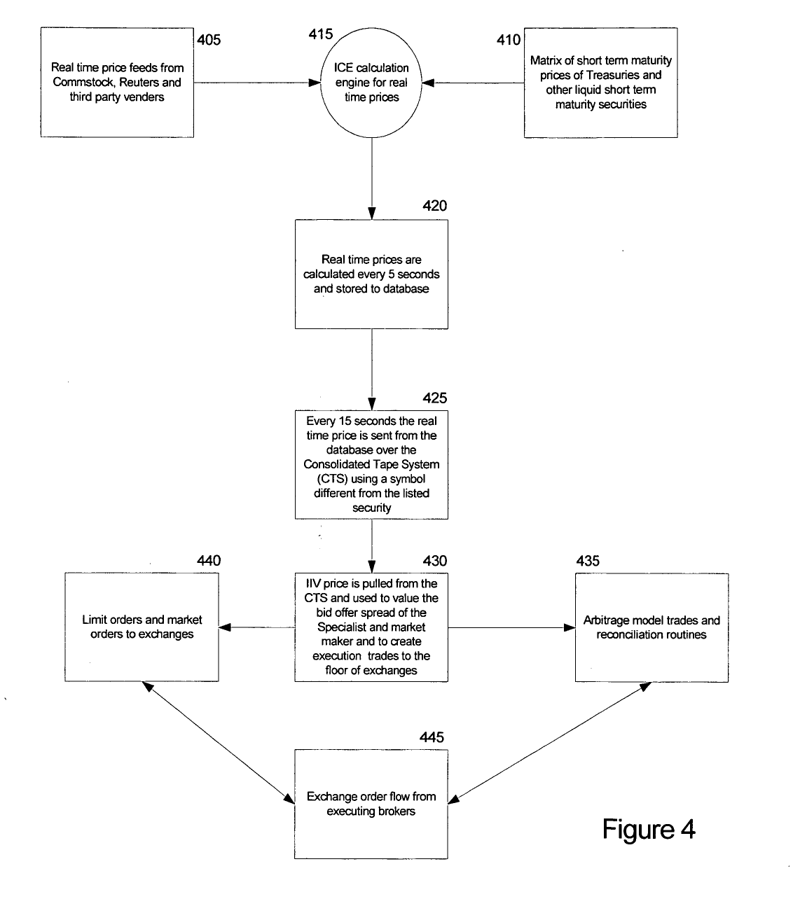

An Index Calculation Engine (ICE) publishes the interest rate and fair value (IIV) of the MMETF 320. The ICE is a computer program product that is designed to calculate and publish the IIV of an MMETF. The IIV is published in real time, for example, every 15 seconds, over the consolidated tape system (CTS) 325. Further details on IIV calculation and publication are provided in FIG. 4 and the accompanying text. Investors can monitor the CTS in order to see the real-time fair value of MMETFs 330. Investors can compare the prices at which MMETF shares are actually trading with the published IIV price 312 and use that comparison to decide whether to invest.

Data characterizing executed trades (security, order size, price) are sent to the clearance system 310 for trade comparison. If there are no discrepancies for the executed trade, the data characterizing the executed trade is sent back to the originating broker 312 for notice and confirmation to the investor. If there are discrepancies between the broker's data and the exchange member's data regarding the trade, the trade exceptions are resolved 335 and resubmitted to the clearance system 310.

Trades involving creation and redemption of shares 345 are accounted for in the CNS/NSCC system. Data regarding a confirmed trade is sent from the clearance system to CNS/NSCC for trade settlement on a T+3 settlement schedule 340. Alternatively, settlement for creation and redemption, or secondary market trading, may settle on a T+0, T+1, T+2, . . . T+n settlement schedule 350, where n is a predetermined number of days specified by the fund company, or agreed upon by the fund company and the authorized participant buying or redeeming shares.

FIG. 4 details the process for calculation of the intraday indicative value (IIV) of shares of MMETFs and how that data is used in trading MMETF shares. It is anticipated that this process will be most useful with the Rule 2a-7 non-compliant versions of the invention because the Rule 2a-7 compliant MMETFs are expected to maintain a constant value, e.g., $1.00 per share. The Rule 2a-7 non-compliant MMETFs may have a floating value, however, that would need to be estimated in order to provide investors with sufficient information on which to base a decision whether to trade shares of MMETFs.

The ICE calculation engine 415 is a software program running on a computer system, for example, in an exchange, for calculating real time indicative per fund share values for MMETFs. It takes as an input a matrix of short term maturity prices of treasuries and other liquid short term maturity securities 410 that are comparable to the securities held by the MMETF. Another input is the real time price feeds from Commstock, Reuters, and other third party vendors that provides real time prices for publicly traded securities, possibly including securities held in the MMETF. The data from the real time price feeds and the matrix of short term maturity security prices are used to calculate the real time value of shares of the MMETF 420, for example, every 5 seconds. The calculated real time value is then stored in a database.

Every 15 seconds, the calculated real time price (IIV) is sent from the database over the consolidated tape system (CTS) 425, using a stock symbol that is different than the listed security, in order to allow investors to monitor its value to the prices being quoted by the market. The IIV price is pulled from the CTS and used by investors to value the bid offer spread of specialists and market makers 430, and to create execution trades to the floor of exchanges. Investors, for example through their brokers 445, use the published IIV price 430 to base their orders 440, e.g., limit orders, market orders, etc., the types of acceptable orders varying from exchange to exchange, as discussed above.

Arbitrageurs and other APs can use the same PCF used by the ICE to calculate the IIV in order to independently calculate a fair value for shares of the MMETF and compare it to the published IIV 435. The published IIV 430 can be used by arbitrageurs 435 to determine the fair value of shares of the MMETF and decide whether to initiate an arbitrage transaction if the trading value based on the IIV deviates from the fair value. Other APs can use the IIV in reconciliation routines 435 to compare the published IIV 430 with a value independently calculated based on the same PCF in order to check the published IIV and determine if any errors were made in the PCF file during its preparation.

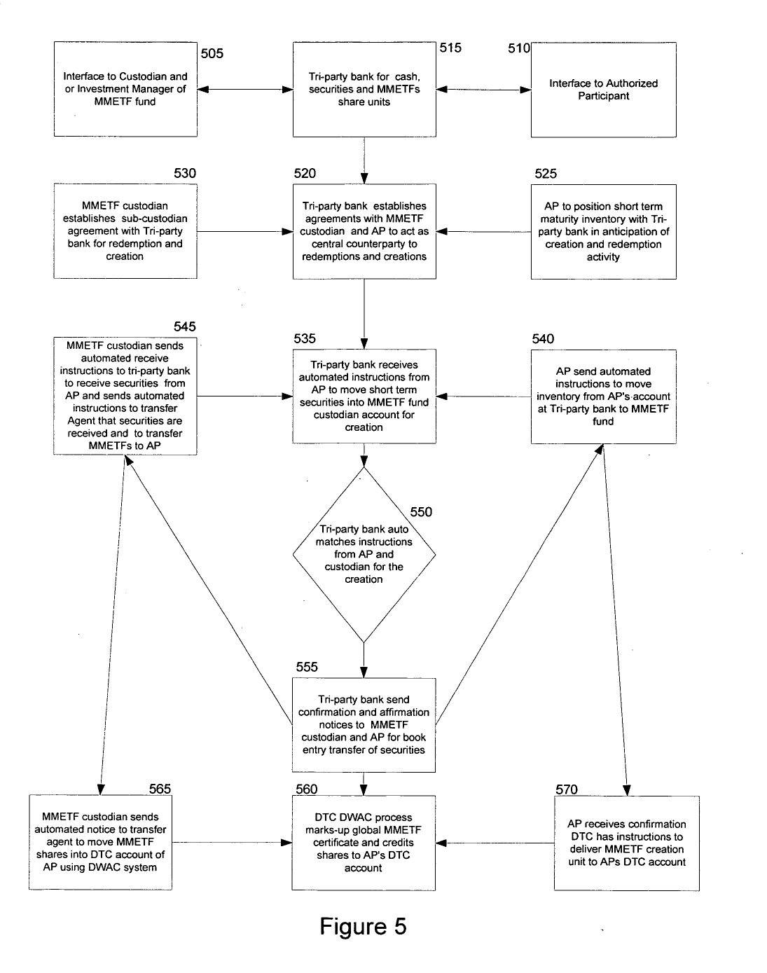

FIG. 5 provides details on the tri-party bank settlement system of an embodiment of the invention to allow short settlement times for both creation and redemption transactions. A tri-party bank receives cash, securities, and shares of MMETFs from authorized participants 510 and the custodian and/or investment manager for a MMETF 505. The tri-party bank establishes agreements with the MMETF custodian and APs to act as a central counterparty for redemption and creation transactions between the fund and APs 520. The AP may provide an inventory of short-term maturity securities to the tri-party bank 525 in anticipation of in-kind creation. Alternatively, the AP may provide cash. The MMETF custodian establishes a sub-custodian agreement with the tri-party bank for redemption and creation 530.

The exchange of MMETF shares for cash or securities can be automated. The AP may send automated instructions 540 to move inventory (cash or securities) from the AP's account at the tri-party bank to the MMETF's account. In return, the MMETF custodian may send automated receive instructions to the tri-party bank to receive the inventory (cash or securities) 545 from the AP's account, and instructions to transfer MMETF shares to the AP's account. The tri-party bank receives the automated instructions from the MMETF custodian and the AP 535, and moves the inventory from the AP's account into the MMETF account, and moves shares of the MMETF from the MMETF account into the AP's account in an auto matching process 550. The tri-party bank sends confirmation and affirmation notices to both the MMETF custodian and the AP for book entry of the transfer of securities 555.

The MMETF custodian sends an automated notice to a transfer agent, the party responsible for maintaining a list of the names of all holders in a corporation, to move MMETF shares into the DTC account of the AP using the DWAC system 565, and the AP receives confirmation that the DTC has the instructions to deliver a MMETF creation unit to the AP's DTC account 570. The transaction is finalized when the DTC DWAC process marks up global MMETF certificates and credits shares of the MMETF to the AP's DTC account 560.

As will be immediately appreciated by those of ordinary skill in the art, modern exchange transactions involve communication among a number of computer systems. For example, a MMETF company will have one or more computer systems to maintain account data and to send transaction data to exchanges and/or tri-party banks. Authorized participants, investors, brokers, specialists, and market makers likewise have one or more computer systems for keeping track of accounts and transactions and for sending data to other networked computer systems specifying details of requested transactions, including the identity of the security to be bought or sold, the number of shares to be bought or sold, and the price per share. Tri-party and custodian banks have one or more computer systems to receive data from outside computer systems and to maintain account databases. The FED and the DTCC likewise maintain computer systems to receive data from outside computer systems regarding the details of transactions and maintaining account databases. Public exchanges such as the American Stock Exchange maintain computer systems for automated order execution, account databases, and data transfer to outside computer systems. Any or all of these aforementioned systems may be involved in various aspects and embodiments of the present invention.

1. An exchange traded cash investment fund product comprising:
an investment fund with substantially all of its assets invested in short-term debt securities,
wherein shares of the fund are purchased with an in-kind creation basket or cash on a first day using the FED and DTC direct withdrawal at custodian creation process on a DTC computer system.

2. The exchange traded cash investment fund product of claim 1, wherein settlement of the purchase of shares on the first day occurs on the first day.

3. The exchange traded cash investment fund product of claim 2, wherein settlement of the purchase of shares on the first day occurs through a tri-party bank, and wherein the purchaser in an authorized participant who electronically transfers securities comprising the in-kind creation basket or cash in the authorized participant's tri-party bank account, the fund electronically transfers an equivalent value of fund shares in the funds' tri-party bank account, and the tri-party bank electronically transfers the fund shares to the authorized participant's tri-party bank account and the securities or cash into the fund's tri-party bank account.

4. The exchange traded cash investment fund product of claim 3, wherein shares of the fund are traded on an exchange using an exchange computer system with automated order executions.

5. The exchange traded cash investment fund product of claim 4, further comprising a computer system comprising an index calculation engine that calculates an intra-day indicative value of the fund.

6. The exchange traded cash investment fund product of claim 5, wherein the computer system comprising an index calculation engine further comprises a means for publishing the calculated intra-day indicative value of the fund to a consolidated tape system.

7. An traded cash investment fund product comprising:
an investment fund with substantially all of its assets invested in short-term debt securities,
wherein shares of the fund are redeemed with an in-kind redemption basket or cash on a second day using the FED and DTC direct withdrawal at custodian redemption process on a DTC computer system.

8. The exchange traded cash investment fund product of claim 7, wherein settlement of the redemption of shares on the second day occurs on the second day.

9. The exchange traded cash investment fund product of claim 8, wherein settlement of the purchase of shares on the first day occurs through a tri-party bank, and wherein the purchaser in an authorized participant who electronically transfers securities comprising the in-kind creation basket or cash in the authorized participant's tri-party bank account, the fund electronically transfers an equivalent value of fund shares in the funds' tri-party bank account, and the tri-party bank electronically transfers the fund shares to the authorized participant's tri-party bank account and the securities or cash into the fund's tri-party bank account.

10. The exchange traded cash investment fund product of claim 9, wherein shares of the fund are traded on an exchange using an exchange computer system with automated order executions.

11. The exchange traded cash investment fund product of claim 10, further comprising a computer system comprising an index calculation engine that calculates an intra-day indicative value of the fund.

12. The exchange traded cash investment fund product of claim 11, wherein the computer system comprising an index calculation engine further comprises a means for publishing the calculated intra-day indicative value of the fund to a consolidated tape system.

13. A method for creating shares of an exchange traded cash investment fund product with substantially all of its assets invested in short-term debt securities, comprising the steps of:
accepting an electronic transfer of an in-kind creation basket of securities or cash from an authorized participant for the purchase of shares of the fund into an account of the authorized participant, the account being in a computerized electronic database of accounts,
accepting an electronic transfer of shares of the fund with an equivalent value to the in-kind creation basket of securities or cash into an account of the fund, the account being in the computerized electronic database of accounts,
electronically transferring the in-kind creation basket of securities or cash from the account of the authorized participant into the account of the fund, and
electronically transferring the shares of the fund from the account of the fund into the account of the authorized participant,
wherein both of the accepting steps and both of the electronically transferring steps occur on the same day.

14. The method of claim 13, wherein a tri-party bank computer system executes both of the accepting steps and both of the electronically transferring steps.

15. The method of claim 14, wherein shares of the fund are traded on an exchange using an exchange computer system with automated order executions.

16. The method of claim 15, further comprising the steps of:
comparing data from the exchange regarding the trade of the shares of the fund with data from a broker regarding the trade of the shares of the fund,
finding a difference between the data from the exchange and the data from the broker, and resolving the difference.

17. The method of claim 15, further comprising the step of calculating an intra-day indicative value of the fund on a computer system.

18. The method of claim 17, further comprising the step of electronically sending the calculated intra-day indicative value of the fund to a consolidated tape system.

19. The method of claim 17, further comprising the step of daily electronically transferring data comprising a portfolio composition file that contains a database of the quantity of each of the securities held by the fund to authorized participants from a computer system maintained by the fund.

20. The method of claim 19, further comprising the steps of:
electronically calculating a value of the fund using the portfolio composition file on a computer system maintained by an authorized participant, and
comparing the value of the fund calculated by the computer system maintained by the authorized participant using the portfolio composition file with the intra-day indicative value.
